(19) United States
(12) Patent Application Publication
(10) Pub. No.: US 2010/0264647 A1
(43) Pub. Date: Oct. 21, 2010

(54) SPRAY SHIELD FOR COOLING IN COMPUTING SYSTEMS

(75) Inventors: Charles C. Gange, Rhinebeck, NY (US); Robert K. Mullady, Highland, NY (US)

Correspondence Address: Kenneth L. Sherman, Esq.;c/o MYERS ANDRAS SHERMAN LLP, 19900 MacArthur Blvd., Suite 1150, Irvine, CA, 92612, US

(73) Assignee: International Business Machines Corporation, Armonk, NY (US)

(21) Appl. No.: 12/427,530

(22) Filed: Apr. 21, 2009

(51) Int. Cl. F16L 39/02

(52) U.S. Cl. 285/123.3

(57) ABSTRACT

A spray shield for a quick-disconnect fitting of a liquid cooling system for a computing system. The spray shield includes a first shield element and a second shield element. The first shield element and the second shield element having interlocking members for removably engaging the first shield element to the second shield element, forming a shield sleeve suitable for surrounding a connection between a quick-disconnect fitting and an actuator fitting. The shield sleeve substantially shields surroundings from cooling liquid spray from the connection.

### BACKGROUND

1. Field of the Invention

The present invention relates generally to cooling systems for computing machines, and in particular, to liquid cooling systems for computing machines.

2. Background Information

Liquid cooling assemblies are used for cooling computing systems. Water cooling systems typically involve hoses delivering water to distribution manifolds for cooling devices. Quick-disconnect water fittings present challenges when placed in a rack mounted system and used in close proximity to electrical components. When a quick-disconnect fitting is actuated, accidental water spray from a water cooled component must be guarded against.

### BRIEF SUMMARY

A spray shield for a quick-disconnect fitting of a liquid cooling system for a computing system. The spray shield includes a first shield element and a second shield element. The first shield element and the second shield element having interlocking members for removably engaging the first shield element to the second shield element, forming a shield sleeve suitable for surrounding a connection between a quick-disconnect fitting and an actuator fitting. The shield sleeve substantially shields surroundings from cooling liquid spray from the connection.

The first shield element may have a generally semicylindrical shape, forming a half cylinder divided lengthwise. The second shield element may have a generally semicylindrical shape, forming a half cylinder divided lengthwise.

The first and second shield elements may comprise color coded clear plastic.

The shield may be elongate in shape and include a flared area at one end for grasping control of the shield by two fingers of a user.

The first and second shield elements may include interior contours substantially matching exterior contours of the quick-disconnect fitting and the actuator fitting.

Other aspects and advantages of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

For a fuller understanding of the nature and advantages of the invention, as well as a preferred mode of use, reference should be made to the following detailed description read in conjunction with the accompanying drawings, in which:

FIG. 1 illustrates an exploded perspective view of a spray shield;

FIG. 2 illustrates an assembled spray shield surrounding an actuation sleeve disconnected from a quick-disconnect fitting;

FIG. 3 illustrates an assembled spray shield surrounding an actuation sleeve connected to a quick-disconnect fitting.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of water spray shields, as well as operation and/or component parts thereof. While the following description will be described in terms of water spray shield for use in computing systems, it should be kept in mind that the teachings herein may have broad application to all types of systems, devices and applications.

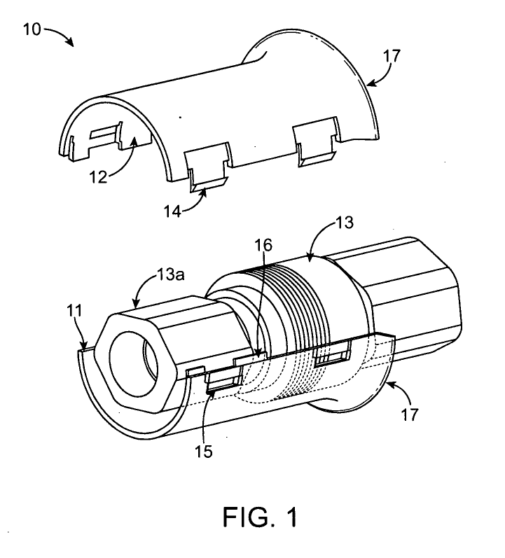

In one embodiment, a two-piece shield is provided that fits around the actuation sleeve of quick-disconnect fitting, and snaps together. FIG. 1 shows an example two-piece shield 10, including elements 11 and 12, snapped together into a shield sleeve 10 fitting around an actuation sleeve 13 of a quick-disconnect fitting 13a which transports water. The elements 11, 12 can be made of clear plastic or other materials.

The interlocking elements 11, 12 include pairs of engagement members 14 and 15 (e.g., hook and loop) that removably engage each other (e.g., snap together). The interior of the interlocking elements 11, 12 include contours 16 that substantially match the exterior contours of the actuation sleeve 13 and quick-disconnect fitting 13a, wherein when the interlocking elements 11 and 12 are engaged, the sleeve 10 substantially locks onto the actuation shield sleeve 13 and quick-disconnect fitting 13a.

A flared area 17 on an exterior of the sleeve 10 provides an improved “grip area” that would make it easier to actuate the fitting 13, especially when the fitting 13 is placed in an area where hand access is limited. This flared area 17 may be accessible from either side of the quick-disconnect water fitting 13, from one side by pulling on the flared area 17 and from the other side by pushing against the flared area 17.

The flared area 17 may be color coded to improve visibility of the feature and suggest its importance for manipulating the shield. The color coding may be visible from either direction. The shield 10 controls any water that may spray on to adjacent electronic components.

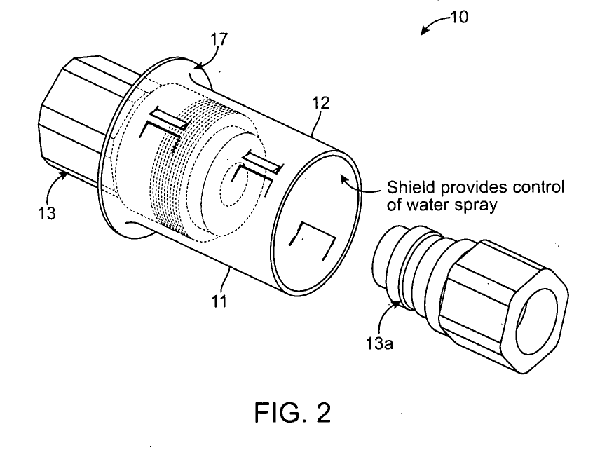

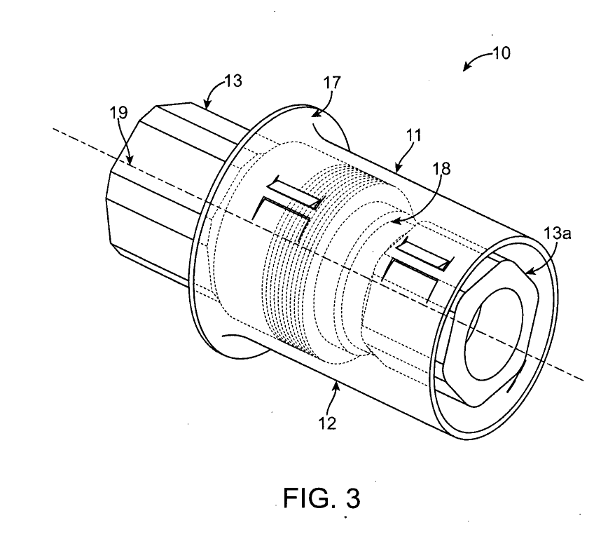

FIG. 2 shows the interlocking elements 11 and 12 forming the shield 10 fitting around the actuation sleeve 13 of the quick-disconnect fitting 13a. The actuation sleeve 13 and the quick-disconnect fitting 13a are shown disconnected. The sleeve 10 controls water spray from any gap in connection 18 between the actuation sleeve 13 and the quick-disconnect fitting 13a when connected, such as shown in FIG. 3.

FIG. 3 shows the interlocking elements 11 and 12 forming the shield 10 fitting around (surrounding) the actuation sleeve 13 and the quick-disconnect fitting 13a, and controlling water spray from any gap between the actuation sleeve 13 and the quick-disconnect fitting 13a. The actuation sleeve 13 and the quick-disconnect fitting 13a are shown connected.

In this example, the elements 11 and 12 are similar in shape and size, being generally semicylinders (i.e., half of a cylinder divided lengthwise along the length/axis 19 of the shield 10 and actuation sleeve 13). The shape of the elements 11 and 12 can be selected to match that of the exterior of the fittings 13 and 13a for a proper surround and locking thereto.

The flared area 17 on the spray shield 10 provides a convenient push/pull grip area that can be used to actuate the quick-disconnect fitting 13a. The flared area 17 improves the usability of the quick-disconnect fitting 13a. When oriented in a way that allows “push for release”, the tips of user fingers can be used to actuate the fitting 13. When oriented in a way that allows “pull for release”, a hook grip using two fingers can be employed. With a fitting that does not employ the spray shield/grip area 17, the user must use a cylindrical grasp that involves all fingers of the hand and the area needed for proper clearances around the quick-disconnect fitting 13a substantially increases.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A spray shield for a quick-disconnect fitting of a liquid cooling system for a computing system, comprising:
a first shield element;
a second shield element; and
the first shield element and the second shield element having interlocking members for removably engaging the first shield element to the second shield element, forming a shield sleeve suitable for surrounding a connection between a quick-disconnect fitting and an actuator fitting,
wherein the shield sleeve substantially shields surroundings from cooling liquid spray from the connection.

2. The spray shield of claim 1 wherein:
the first shield element has a generally semicylindrical shape, forming a half cylinder divided lengthwise; and
the second shield element has a generally semicylindrical shape, forming a half cylinder divided lengthwise.

3. The spray shield of claim 2 wherein the first and second shield elements comprise color coded clear plastic.

4. The spray shield of claim 2 wherein the shield is elongate in shape and includes a flared area at one end for grasping control of the shield by two fingers of a user.

5. The spray shield of claim 2 wherein the first and second shield elements include interior contours substantially matching exterior contours of the quick-disconnect fitting and the actuator fitting.

6. A method of spray shielding a quick-disconnect fitting of a liquid cooling system for a computing system, comprising:
providing a first shield element, and a second shield element, wherein the first shield element and the second shield element have interlocking members for removably engaging the first shield element to the second shield element; and
interlocking the first and second shield elements to form a shield sleeve suitable for surrounding a connection between a quick-disconnect fitting and an actuator fitting, wherein the shield sleeve substantially shields surroundings from cooling liquid spray from the connection.

7. The method shield of claim 6 wherein:
the first shield element has a generally semicylindrical shape, forming a half cylinder divided lengthwise; and
the second shield element has a generally semicylindrical shape, forming a half cylinder divided lengthwise.

8. The method of claim 7 wherein the first and second shield elements comprise color coded clear plastic.

9. The method of claim 7 wherein the shield is elongate in shape and includes a flared area at one end for grasping control of the shield by two fingers of a user.

10. The method of claim 7 wherein the first and second shield elements include interior contours substantially matching exterior contours of the quick-disconnect fitting and the actuator fitting.
